(19) United States
(12) Patent Application Publication
(10) Pub. No.: US 2015/0277607 A1
(43) Pub. Date: Oct. 1, 2015

(54) INPUT DEVICE AND DISPLAY DEVICE

(71) Applicant: Panasonic Intellectual Property Management Co., Ltd., Osaka (JP)

(72) Inventors: Naoki KOSUGI, Kyoto (JP); Masayuki OYAMADA, Osaka (JP); Takashi KITADA, Osaka (JP); Hiroyuki KADO, Osaka (JP)

(21) Appl. No.: 14/638,192

(22) Filed: Mar. 4, 2015

(30) Foreign Application Priority Data
Mar. 25, 2014 (JP) 2014-061338
Sep. 30, 2014 (JP) 2014-201771

(51) Int. Cl. G06F 3/041

(52) U.S. Cl. CPC G06F 3/041

(57) ABSTRACT

An input device includes a touch sensor and a position detection unit. The touch sensor detects touch operations and output a detection value for each of detection regions. The position detection unit detects touch positions touched in the touch operations, based on the detection values from the touch sensor. The position detection unit performs emphasizing conversion process for converting the detection values of a target detection region to emphasize difference in detection values between the target detection region and neighboring regions which are the detection regions within a predetermined range around the target detection region. The target detection region is a detection region to be subjected to the emphasizing conversion process. The position detection unit detects the touch positions based on the converted detection value obtained by the emphasizing conversion process.

### BACKGROUND

1. Technical Field

The present disclosure relates to an input device that has an input function of receiving a touch operation and a display device provided with the input device.

2. Related Art

Display devices each provided with an input device that has a screen input function for a user to input information by a touch operation on a display screen with a finger or the like have been used in mobile electronic devices such as PDAs and portable terminals, various home appliances, and stationary customer information terminals such as unmanned reception machines. As a touch detection method for the input devices each having an input function of receiving a touch operation, there has been known an electrostatic capacitive coupling method that detects a change in capacitance.

An electrostatic capacitive coupling type touch panel has high transmittance (approximately 90%) so that the touch panel can reduce degradation of display image quality. The electrostatic capacitive coupling type touch panel is further advantageous in terms of durability since the touch panel has electrodes for coordinate detection that do not come into mechanical contact with other electrodes.

With respect to a display device having a touch sensor function such as an electronic board, there has been a demand for a large-sized display device which can be manufactured at a low cost. To satisfy such a demand, the development of a multi display which is constituted by arranging a plurality of small-sized display devices or panels has been progressed. Further, with the enlargement of the display device, it is desired that a function of receiving inputs by a multi-touch operation to touch multiple points simultaneously is implemented in the large display panel.

JP 2012-160172 A discloses technology which determines valid touch levels by adaptively removing noise touch levels among the input touch levels based on a distribution of input touch levels, and determines one or more touch points among the panel points having the valid touch levels by performing near-touch separation based on the valid touch levels.

### SUMMARY

It is an object of the present disclosure to provide an input device which has an input function of receiving a touch operation and which is capable of increasing detection accuracy of the multi-touch operation.

An input device according to the present disclosure includes a touch sensor and a position detection unit. The touch sensor is configured to detect touch operations and output a detection value for each of detection regions. The position detection unit is configured to detect touch positions touched by the touch operations, based on the detection values from the touch sensor. The position detection unit performs emphasizing conversion process for converting the detection value of a target detection region to emphasize difference in detection values between the target detection region and neighboring regions which are the detection regions within a predetermined range around the target detection region. The target detection region is a detection region to be subjected to the emphasizing conversion process. The position detection unit detects the touch positions based on the converted detection value obtained by the emphasizing conversion process.

A display device according to the present disclosure includes the input device and a display unit having a display surface configured to display an image.

According to the input device in the present disclosure, by emphasized difference between the detection value in each of the divisions and the detection values in the divisions in the neighboring region of the aforementioned division, it is capable of increasing detection accuracy of a multi-touch operation.

### BRIEF DESCRIPTION OF DRAWINGS

FIG. 1 is a block diagram for describing an overall configuration of a liquid crystal display device according to the first embodiment.

FIG. 2 is a block diagram illustrating detail configuration of the touch panel according to the first embodiment.

FIG. 3 is a diagram illustrating an example of arrangement of the drive electrodes and the sensing electrodes included in the touch sensor.

FIG. 4A is a diagram of a schematic configuration and an equivalent circuit of the touch sensor with no touch operation.

FIG. 4B is a diagram of a schematic configuration and an equivalent circuit of the touch sensor with a touch operation.

FIG. 5 is a diagram illustrating a change of the detection signal in the case that the touch operation is performed or not performed.

FIG. 6 is a diagram illustrating the array of the scanning signal lines, the array of the drive electrodes and the sensing electrodes.

FIGS. 7A to 7F are diagrams illustrating an example of sequential relationship between input of the scanning signals and supply of the driving signal.

FIG. 8 is a timing chart illustrating a state of application of the scanning signals and the driving signals during one frame period.

FIG. 9 is a timing chart for describing an example of relationship between a display update period and a touch detection period.

FIG. 10 is a diagram illustrating an example of a detection state on the touch panel when the joint portion is touched.

FIG. 11 is a flow chart showing an operation of the position detection circuit 13.

FIG. 12 is a diagram for describing an exemplary processing performed by the position detection circuit 13.

FIG. 13A is a diagram illustrating an example of multi-touch operation.

FIG. 13B is a diagram illustrating the example of the detection values in the case illustrated in FIG. 13A.

FIG. 14A is a diagram illustrating an exemplary calculation of the process of step S110 shown in FIG. 11.

FIG. 14B is a diagram illustrating an exemplary calculation of the process of step S111 shown in FIG. 11.

FIG. 15A is a diagram illustrating the result of the emphasizing conversion process following the case shown in FIG. 14B.

FIG. 15B is a diagram illustrating the determination result of the process of step S112 shown in FIG. 11.

FIG. 16 is a flow chart for describing the emphasizing conversion process of the position detection circuit.

FIGS. 17A and 17B are diagrams for describing the calculation of the step S216 in FIG. 16 for the touch panel 101 and 102, respectively.

FIGS. 18A and 18B are diagrams for describing the calculation of the step S218 in FIG. 16 for the touch panel 101 and 102, respectively.

FIGS. 19A and 19B are diagrams for describing the calculation of the step S220 in FIG. 16 for the touch panel 101 and 102, respectively.

### DETAILED DESCRIPTION

Hereinafter, an embodiment is described in detail while referring to the drawings as appropriate. However, detailed descriptions are sometimes omitted when they are not required. For example, detailed descriptions of already well-known matters and repeated descriptions of substantially identical configurations are sometimes omitted. This has been done in order to avoid the following description from becoming unnecessarily redundant, and to facilitate understanding for persons skilled in the art.

It should be noted that the inventor(s) has provided the appended drawings and the following description in order for persons skilled in the art to sufficiently understand the present disclosure, not with the intention of thereby restricting the subject described in the claims.

### First Embodiment

The first embodiment will be described below with reference to the attached drawings.

### 1-1. Configuration

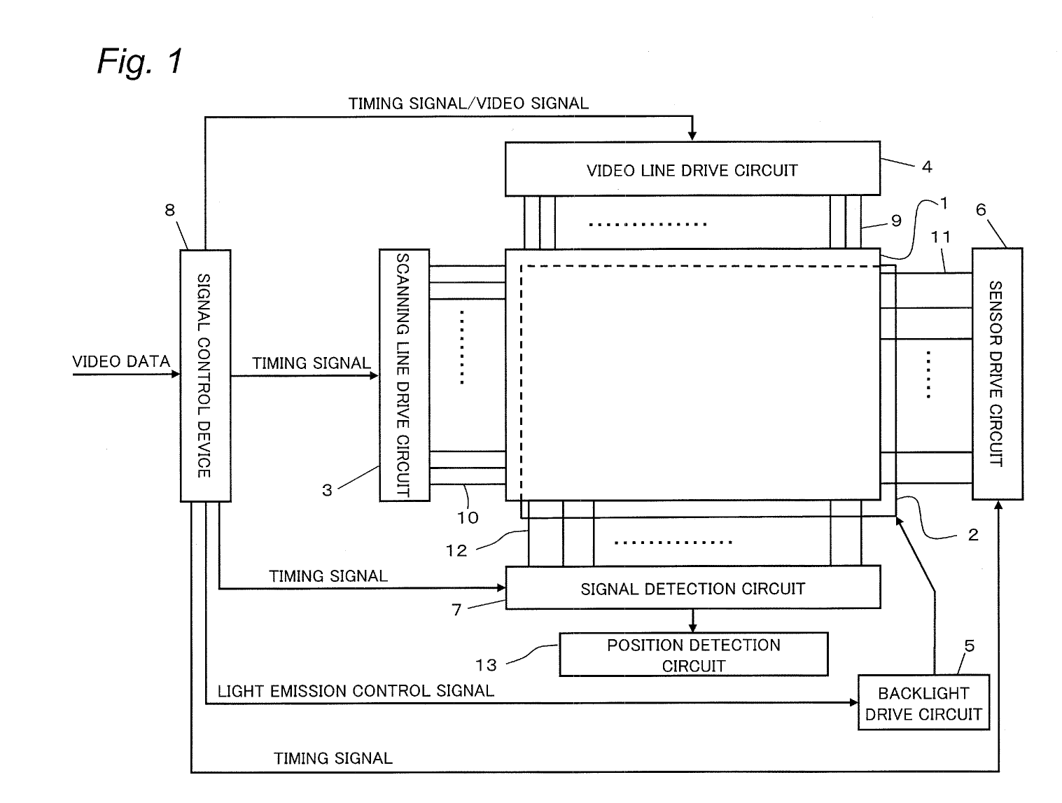

FIG. 1 is a block diagram for describing an overall configuration of a liquid crystal display device provided with a touch sensor which is an input device according to the first embodiment. As illustrated in FIG. 1, the liquid crystal display device includes a display unit 1, a backlight unit 2, a scanning line drive circuit 3, a video line drive circuit 4, a backlight drive circuit 5, a signal control device 8, and a position detection circuit 13.

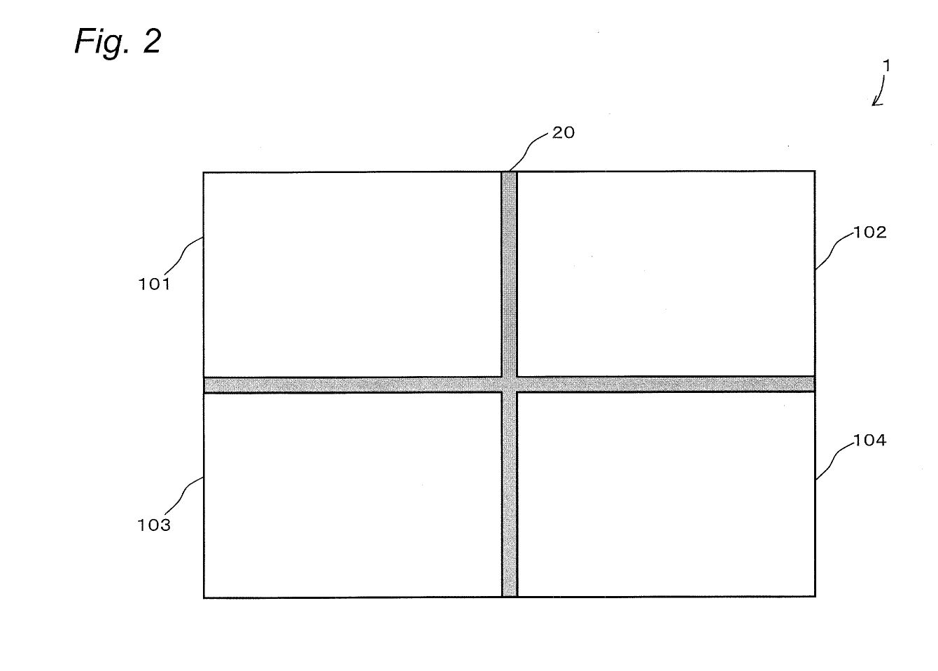

The display unit 1 displays an image and a character on a display surface. The display unit 1 is configured by a plurality of liquid crystal panels. Each liquid crystal panel is a touch panel that has a touch sensor function. As illustrated in FIG. 2, four touch panels 101 to 104 are arranged at predetermined intervals, and constitute the display unit 1 as one panel with each of the touch panels joined at the intervals by a joint portion 20. The joint portion 20 is made of resin, for example. However, the material for the joint portion 20 is not limited to resin, and any material may be used as long as it is visually inconspicuous.

Since the respective touch panels 101 to 104 have the same configuration, the touch panel 101 will be described as an example herein. The touch panel 101 includes a TFT substrate made of a transparent substrate such as a glass substrate and a counter substrate that is arranged opposite to the TFT substrate with a predetermined gap from the TFT substrate, and is configured to enclose a liquid crystal material between the TFT substrate and the counter substrate.

The TFT substrate is located on a back side of the display unit 1. Pixel electrodes arrayed in a matrix form, thin film transistors (TFT) provided correspondingly to the pixel electrodes to serve as switching elements for on-off control of voltage application to the pixel electrodes, common electrodes, and the like are formed on a substrate that constitutes the TFT substrate.

The counter substrate is located on a front side of the display unit 1. On a transparent substrate that constitute the counter substrate, there are formed color filters (CF) of at least three primary colors of red (R), green (G), and blue (B) at positions corresponding to the pixel electrodes; a black matrix that is made of a light-shielding material for enhancing contrast and arranged between respective subpixels of RGB and/or between pixels constituted of the subpixels of RGB; and the like. Hereinafter, the present embodiment will be described on the assumption that the Ms formed on the TFT substrate for the respective subpixels are re-channel Ms.

On the TFT substrate, a plurality of video signal lines 9 and a plurality of scanning signal lines 10 are formed so that the video signal lines 9 and the scanning signal lines 10 are substantially orthogonal to each other. Each of the scanning signal lines 10 is arranged in a horizontal direction of the TFTs and commonly connected to gate electrodes of the plurality of TFTs. Each of the video signal lines 9 is arranged in a vertical direction of the TFTs and commonly connected to drain electrodes of the plurality of TFTs. The pixel electrodes arranged in pixel regions corresponding to the TFTs are connected to source electrodes of the respective TFTs.

The respective TFTs formed on the TFT substrate are under on-off operation control in predetermined units in response to scanning signals applied to the scanning signal lines 10. The respective TFTs in a horizontal line controlled to be turned on set electric potentials of the pixel electrodes (pixel voltages) according to video signals applied to the video signal lines 9. Therefore, the display unit 1, which has the plurality of pixel electrodes and the common electrodes provided opposed to the pixel electrodes, controls orientation of liquid crystal for each pixel region by using an electric field generated between the pixel electrode and the common electrode to change the transmittance for light entered from the backlight unit 2, so that an image is formed on the display surface.

The backlight unit 2 is arranged on the back side of the display unit 1 and is configured to irradiate light from the back side of the display unit 1. For the backlight unit 2, there have been known a structure in which a plurality of light-emitting diodes are arranged to form a surface light source, and a structure in which a surface light source is constructed to use light irradiated from light-emitting diodes in combination with a light guide plate and a diffuse reflection plate, for example.

The scanning line drive circuit 3 is connected to the plurality of scanning signal lines 10 formed on the TFT substrate. The scanning line drive circuit 3 sequentially selects the scanning signal lines 10 in response to a timing signal input from the signal control device 8, and applies voltage to the selected scanning signal line 10 to turn on the TFT. For example, the scanning line drive circuit 3 includes a shift register. The shift register is activated in response to a trigger signal from the signal control device 8, sequentially selects the scanning signal lines 10 along a vertical scanning direction, and outputs a scanning pulse to the selected scanning signal line 10.

The video line drive circuit 4 is connected to the plurality of video signal lines 9 formed on the TFT substrate. Together with the selection of the scanning signal lines 10 by the scanning line drive circuit 3, the video line drive circuit 4 applies voltage in accordance with the video signal that represents a gradation value of each subpixel to each of the TFTs connected to the selected scanning signal line 10. As a result, the video signals are written in the subpixels corresponding to the selected scanning signal line 10.

The backlight drive circuit 5 causes the backlight unit 2 to emit light at timing and with luminance according to a light emission control signal input from the signal control device 8.

In the present embodiment, an electrostatic capacitive touch sensor is adopted. The touch sensor includes a plurality of drive electrodes 11 and a plurality of sensing electrodes 12. The plurality of drive electrodes 11 and the plurality of sensing electrodes 12 are arranged on the touch panel 101 to cross each other. The drive electrodes 11 and the sensing electrodes 12 are examples of the first and second electrodes, respectively.

The touch sensor including the drive electrodes 11 and the sensing electrodes 12 performs response detection in which an input of an electric signal causes a change of electrostatic capacitance between the drive electrodes 11 and the sensing electrodes 12, and detects contact (proximity) of an object to the display surface (detection region). A sensor drive circuit 6 and a signal detection circuit 7 are provided as electric circuits for detecting the contact.

The sensor drive circuit 6, which is a circuit for generating an AC signal, is connected to the drive electrodes 11. For example, the sensor drive circuit 6 receives the timing signal input from the signal control device 8, sequentially selects the drive electrodes 11 in synchronization with image display on the display unit 1, and supplies a driving signal Txv by rectangular pulse voltage to the selected drive electrode 11. For example, the sensor drive circuit 6 includes a shift register similarly to the scanning line drive circuit 3. The shift register is activated in response to a trigger supplies from the signal control device 8, sequentially selects the drive electrodes 11 along a vertical scanning direction, and supplies the driving signal Txv by pulse voltage to the selected drive electrode 11.

The drive electrodes 11 and the scanning signal lines 10 extend in the horizontal direction of the TFT substrate (direction of columns), and a plurality of drive electrodes 11 and scanning signal lines 10 are arranged in the vertical direction of the TFT substrate (direction of rows). The sensor drive circuit 6 and the scanning line drive circuit 3 electrically connected to the drive electrodes 11 and the scanning signal lines 10 are located on the respective sides in the width direction (the horizontal direction) of a display area where the pixels are arranged, such that the scanning line drive circuit 3 is located on one side in the width direction and the sensor drive circuit 6 is located on the other side in the width direction. Both of the scanning line drive circuit 3 and the sensor drive circuit 6 may be arranged at one side in the width direction of the display area or may be extracted in other directions depending on wiring around the panel.

The signal detection circuit 7 is a circuit for detecting a change of electrostatic capacitance, and is connected to the sensing electrodes 12. The signal detection circuit 7 is provided with a detection circuit with respect to each of the sensing electrodes 12, and outputs the change of electrostatic capacitance detected in the sensing electrodes 12 as a detection signal Rxv. As another configuration example, the signal detection circuit 7 may be provided with one detection circuit for a group of sensing electrodes 12, and may perform detection of the detection signal Rxv for each group of sensing electrodes 12 in a time-sharing manner at a plurality of applications of pulse voltage to the drive electrodes 11.

A position at which an object contacts the display surface is determined based on determination results which one of the drive electrodes 11 the driving signal Txv is applied to and, in that time, which one of the sensing electrodes 12 a signal generated in response to the contact is detected in. An intersection point of the drive electrode 11 to which the driving signal Txv is applied and the sensing electrode 12 from which the detection signal Rxv is received is determined as a contact position as a result of arithmetic operation. The liquid crystal display device may be provided with an arithmetic circuit to perform the arithmetic operation for determining the contact position, or an arithmetic circuit outside the liquid crystal display device may be used for the arithmetic operation.

The signal control device 8 is provided with an arithmetic processing circuit such as a CPU and a memory such as a ROM and a RAM. The signal control device 8 generates an image signal that indicates the gradation value of each subpixel by performing various types of image signal processing including color adjustment based on input video data, and supplies the image signal to the video line drive circuit 4. Further, the signal control device 8 generates timing signals based on the input video data, and supplies the respective timing signals to the scanning line drive circuit 3, the video line drive circuit 4, the backlight drive circuit 5, the sensor drive circuit 6, and the signal detection circuit 7. Furthermore, based on the input video signal, the signal control device 8 supplies a luminance signal for controlling the luminance of the light-emitting diode as a light emission control signal to the backlight drive circuit 5.

A position detection circuit 13 detects a touch (contact) position on the display unit 1 by using the detection signal Rxv output from the signal detection circuit 7. Details of a method of detecting the touch position will be described later. The position detection circuit 13 is an example of the position detection unit.

In the present embodiment, the scanning line drive circuit 3, the video line drive circuit 4, the sensor drive circuit 6, the signal detection circuit 7, and the position detection circuit 13, which are connected to the respective signal lines and electrodes of the display unit 1 are configured by semiconductor chips of the respective circuits mounted on a flexible wiring board, a printed circuit board, or a glass substrate. However, each of the scanning line drive circuit 3, the video line drive circuit 4, the sensor drive circuit 6, the signal detection circuit 7, and the position detection circuit 13 may be formed on the TFT substrate concurrently with the TFTs.

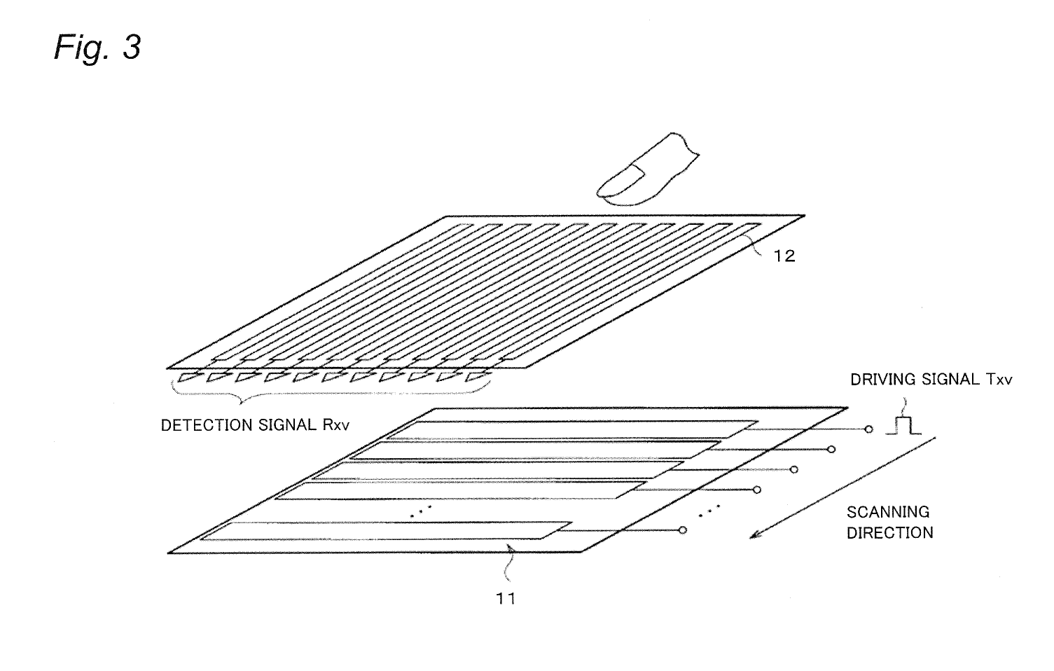

FIG. 3 is a diagram illustrating an example of arrangement of the drive electrodes 11 and the sensing electrodes 12 included in the touch sensor. As illustrated in FIG. 3, the touch sensor as the input device includes the drive electrodes 11 that form an electrode pattern of a plurality of stripes extending in the horizontal direction (a right-left direction in FIG. 2) and the sensing electrodes 12 that are a plurality of electric conductors having stripe forms extending in a direction crossing the extending direction of electric conductors of the drive electrodes 11. A capacitive element having electrostatic capacitance is formed on each intersection of the drive electrodes 11 and the sensing electrodes 12.

The array of the drive electrodes 11 extend in a direction parallel to the direction in which the scanning signal lines 10 extend. Further, on the assumption that M (M is a natural number) scanning signal lines 10 form one line block, the drive electrodes 11 are arranged so that the drive electrodes 11 respectively correspond to N (N is a natural number) line blocks. Details of the arrangement of the drive electrodes 11 will be described later. The drive electrodes 11 apply the driving signal Txv to each of the line blocks.

When a touch detection operation is performed, the driving signal Txv is supplied from the sensor drive circuit 6 to the drive electrodes 11 so as to scan each of the line blocks sequentially in a time-sharing manner. As a result, one line block for the detection target is selected sequentially. Further, since the detection signal Rxv is received from the sensing electrodes 12, touch detection for one line block can be performed.

### 1-2. Operation

### 1-2-1. Principles of Touch Detection

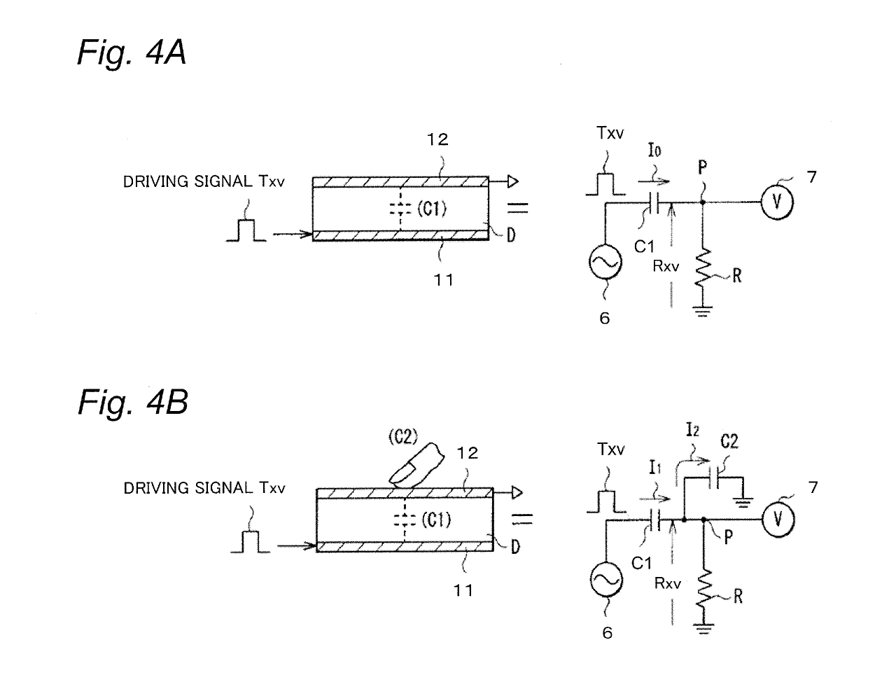

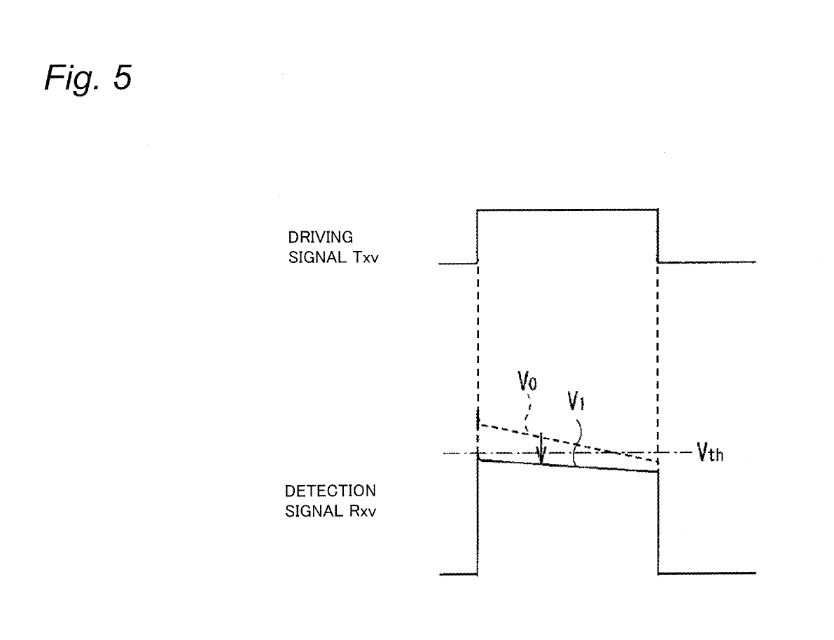

Operation of the liquid crystal display device with the above-described configuration will be described. First, a principle of touch detection of the input device will be described with reference to FIGS. 4A and 4B and FIG. 5. The input device according to the present embodiment adopts a capacitive touch sensor.

FIGS. 4A and 4B are diagrams for describing a schematic configuration and an equivalent circuit of the touch sensor in a state where the touch operation is not performed (FIG. 4A) and in a state where the touch operation is performed (FIG. 4B). FIG. 5 is a diagram illustrating a change of the detection signal in the case as in FIG. 4A or FIG. 4B.

In the electrostatic capacitive touch sensor, a capacitive element is formed on an intersection of a pair of drive electrode 11 and sensing electrode 12 which cross each other (see FIG. 3). Specifically, as illustrated in FIG. 4A, a capacitive element C1 is configured by the drive electrode 11, the sensing electrode 12, and a dielectric body D. One end of the capacitive element C1 is connected to the sensor drive circuit 6 which serves as an AC signal source, and the other end P of the capacitive element C1 is grounded via a resistor R and connected to the signal detection circuit 7 which serves as a voltage detector.

When the driving signal Txv is applied from the sensor drive circuit 6 as the AC signal source to the drive electrode 11 (the one end of the capacitive element C1) by pulse voltage with predetermined frequency around tens kHz to hundreds kHz (see FIG. 5), an output waveform (detection signal) Rxv as illustrated in FIG. 5 is obtained at the sensing electrode 12 (the other end P of the capacitive element C1).

In a state of not in contact with (or not in proximity to) a finger, as illustrated in FIG. 4A, a current I0 in accordance with a capacitance value of the capacitive element C1 flows, accompanying charge and discharge to the capacitive element C1. An electric potential waveform at the other end P of the capacitive element C1 at this time becomes a waveform V0 of the detection signal Rxv illustrated in FIG. 5, and is detected by the signal detection circuit 7 serving as the voltage detector.

On the other hand, in a state of being in contact with (or in proximity to) a finger, as illustrated in FIG. 4B, a capacitive element C2 formed by the finger is added in series with the capacitive element C1 in the configuration of the equivalent circuit. In this state, currents I1 and I2 flow, accompanying charge and discharge to the capacitive element C1 and the capacitive element C2, respectively. An electric potential waveform at the other end P of the capacitive element C1 at this time becomes a waveform V1 of the detection signal Rxv illustrated in FIG. 5, and is detected by the signal detection circuit 7 serving as the voltage detector. In this state, the electric potential at the point P is defined by values of the currents I1 and I2 flowing through the capacitive elements C1 and C2. Therefore, the amplitude of the waveform V1 takes a smaller value than that of the amplitude of the waveform V0 which is obtained in the noncontact state.

The signal detection circuit 7 compares electric potentials of the detection signals Rxv output from the respective sensing electrodes 12 with a predetermined threshold voltage Vth. If the electric potential is equal to or larger than the threshold voltage, the signal detection circuit 7 determines that it is the noncontact state, and if the electric potential is smaller than the threshold voltage, the signal detection circuit 7 determines that it is the contact state. In this manner, the touch detection can be performed. Other methods of sensing a signal indicating a change in electrostatic capacitance include a method of sensing a current.

### 1-2-2. Method of Driving Touch Sensor

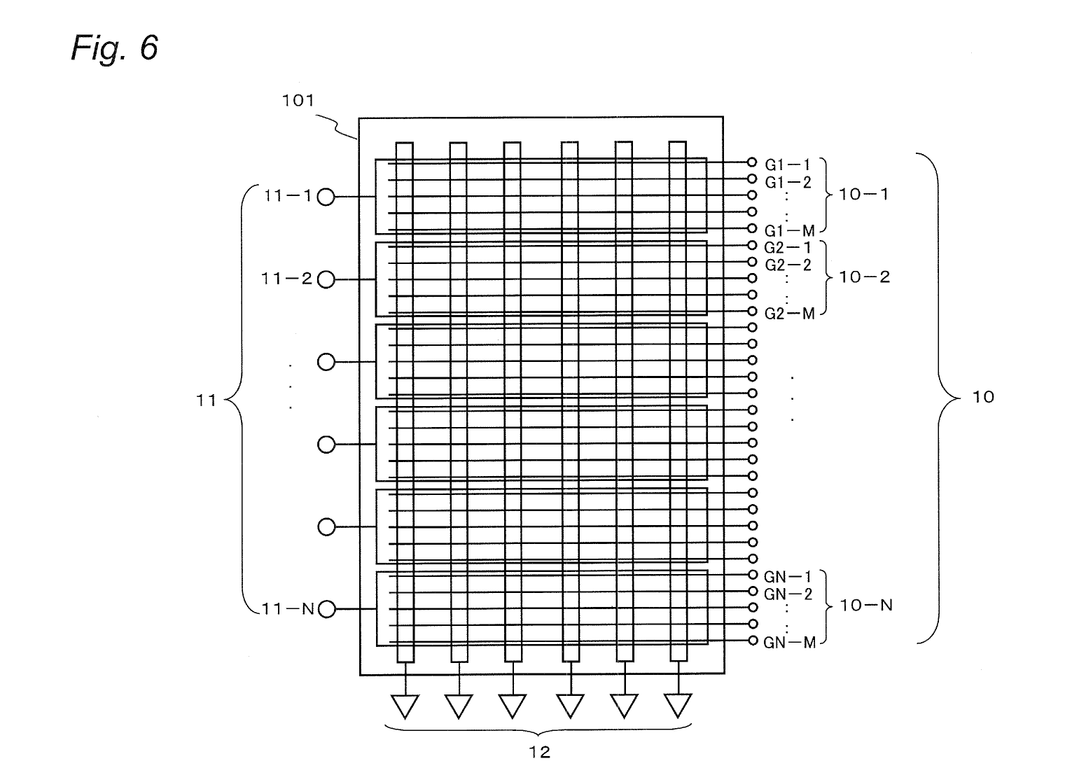

Now, a method of driving the touch sensor in the liquid crystal display device according to the present embodiment will be described with reference to FIG. 6 to FIG. 9.

FIG. 6 is a schematic diagram illustrating the array structure of the scanning signal lines on the liquid crystal panel and the array structure of the drive electrodes and the sensing electrodes in the touch sensor.

X scanning signal lines 10 extending in the horizontal direction are divided into groups each having M (M is a natural number) scanning signal lines Gi-1, Gi-2 . . . Gi-M (i is 1 to N) as illustrated in FIG. 6. Each group is managed as one line block. That is, the scanning signal lines 10 are divided into N (N is a natural number) line blocks 10-1, 10-2 . . . 10-N and arrayed.

The drive electrodes 11 of the touch sensor are arrayed so that N drive electrodes 11-1, 11-2 . . . 11-N extend in the horizontal direction correspondingly to the line blocks 10-1, 10-2 . . . 10-N. The plurality of sensing electrodes 12 are arrayed so that the sensing electrodes 12 cross the N drive electrodes 11-1, 11-2 . . . 11-N.

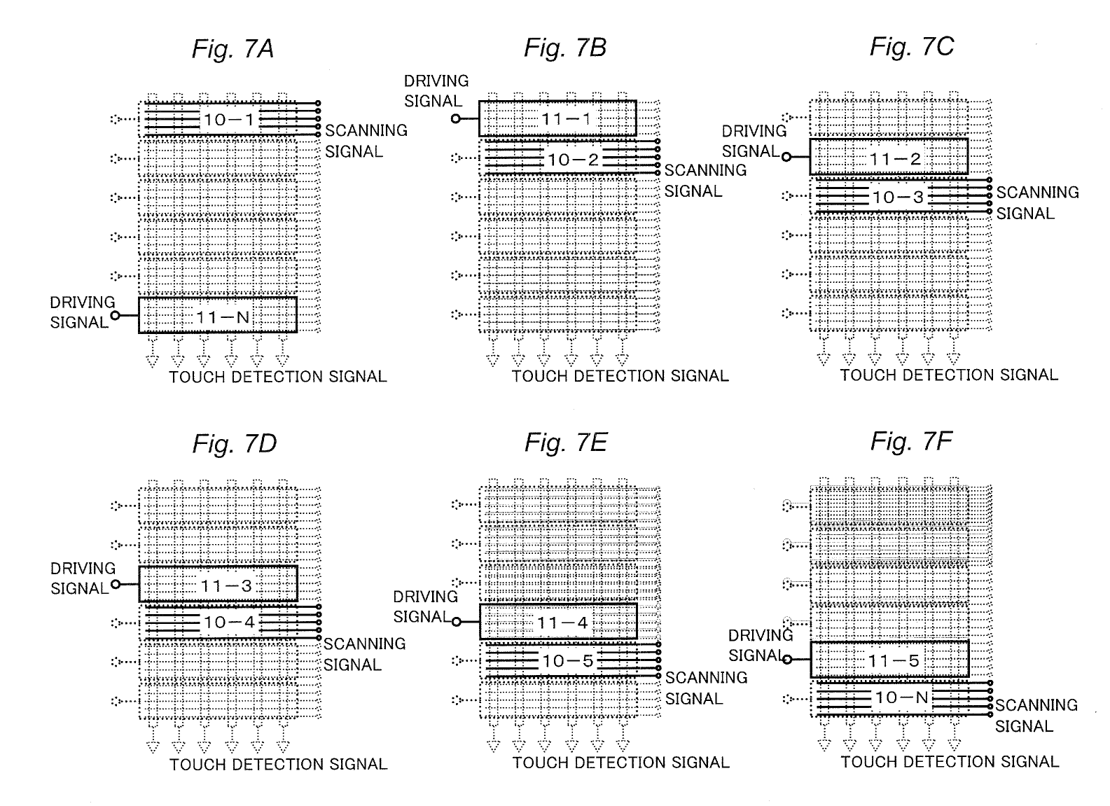

FIGS. 7A to 7F are explanatory diagrams each illustrating an example of relationship between input of the scanning signals to the line block of the scanning signal lines for performing the display update on the liquid crystal panel and supply of the driving signal to the line block of the drive electrodes for performing the touch detection on the touch sensor. FIGS. 7A to 7F each illustrate a state during one line block scanning period. In the present embodiment, the line block of the scanning signal lines to which the scanning signals for performing the display update on the liquid crystal panel are supplied differs from the line block of the drive electrodes to which the driving signal for performing the touch detection on the touch sensor is supplied.

Specifically, as illustrated in FIG. 7A, during a horizontal scanning period in which the scanning signals are sequentially being input to the respective scanning signal lines of the first line block 10-1, the driving signal is supplied to the drive electrode 11-N corresponding to the last line block 10-N. During the subsequent horizontal scanning period, as illustrated in FIG. 7B, the scanning signals are sequentially being input to the respective scanning signal lines of the second line block 10-2 and, also during the same horizontal scanning period, the driving signal is supplied to the drive electrode 11-1 corresponding to the first line block 10-1. During the subsequent horizontal scanning period, as illustrated in FIG. 7C, the scanning signals are sequentially being input to the respective scanning signal lines of the third line block 10-3. Also during the same horizontal scanning period, the driving signal is supplied to the drive electrode 11-2 corresponding to the second line block 10-2.

In the same manner, as illustrated in FIGS. 7D to 7F, the scanning signals are sequentially input to the respective scanning signal lines of the respective line blocks while the line blocks 10-4, 10-5 . . . 10-N are sequentially switched. At the same time, the driving signal is supplied to the drive electrodes 11-3, 11-4, 11-5 corresponding to the line blocks 10-3, 10-4, 10-5, which are preceding line blocks of the line blocks 10-4, 10-5 . . . 10-N to which the scanning signals are supplied.

That is, the liquid crystal display device according to the present embodiment is configured to supply the driving signal to the drive electrodes 11 by selecting the drive electrode 11-i (i=1 to N) corresponding to the line block to which the scanning signals are not applied for the plurality of scanning signal lines during each line block scanning period for performing the display update.

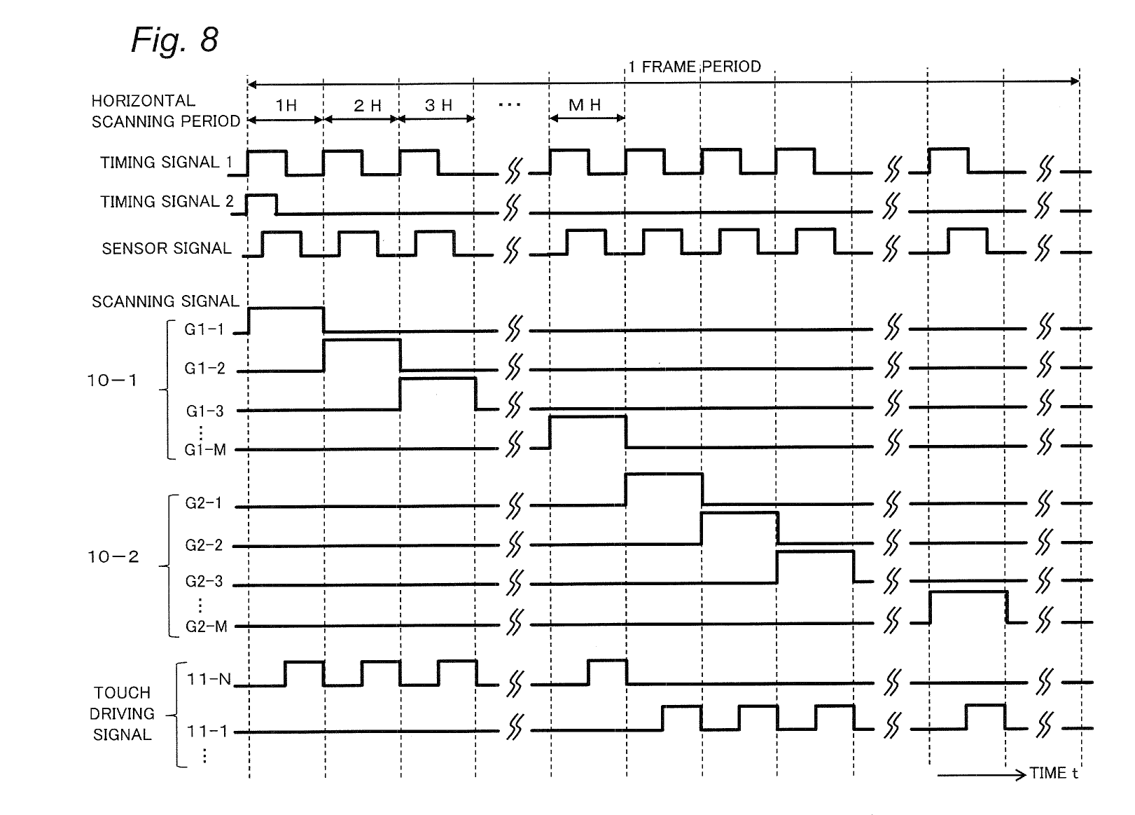

FIG. 8 is a timing chart illustrating a state of application of the scanning signals and the driving signals in the examples illustrated in FIGS. 7A to 7F. FIG. 8 is the timing chart illustrating the touch detection operation in the driving method according to the present embodiment.

As illustrated in FIG. 8, during each of the horizontal scanning periods (1H, 2H, 3H, . . . MH) of one frame period, the liquid crystal display device performs the display update by inputting the scanning signals to the scanning signal lines 10 for each of the line blocks (10-1, 10-2, . . . , 10-N). During the period in which the scanning signals are input to the scanning signal lines 10, the driving signal for performing the touch detection is supplied to the drive electrodes 11-N, 11-1, 11-2, . . . corresponding to the line block to which the scanning signals are not supplied.

The timing signal is generated by the signal control device 8 for the operation of the display unit 1. In FIG. 8, a timing signal 1 is a signal indicating timing of the scanning signal, and a timing signal 2 is a signal indicating timing to start scanning. FIG. 8 illustrates the example where the scanning starts at the line block 10-1. Specifically, when the timing signal 1 is input after input of the timing signal 2, an operation of inputting the scanning signal to the scanning signal line G1-1 starts.

The liquid crystal display device may be provided with a sensor control circuit (not illustrated) which is configured to generate a sensor signal in response to the timing signals input from the signal control device 8, and to control the sensor drive circuit 6 and the signal detection circuit 7 based on the sensor signal. The sensor signal is a signal generated for sensor operation. The sensor control circuit generates the sensor signals with a predetermined delay based on the timing signals 1 and 2 input from the signal control device 8. The sensor drive circuit 6 supplies the driving signal to the drive electrodes 11 based on the sensor signals generated by the sensor control circuit. As illustrated in FIG. 8, the sensor signals synchronize with the scanning signals.

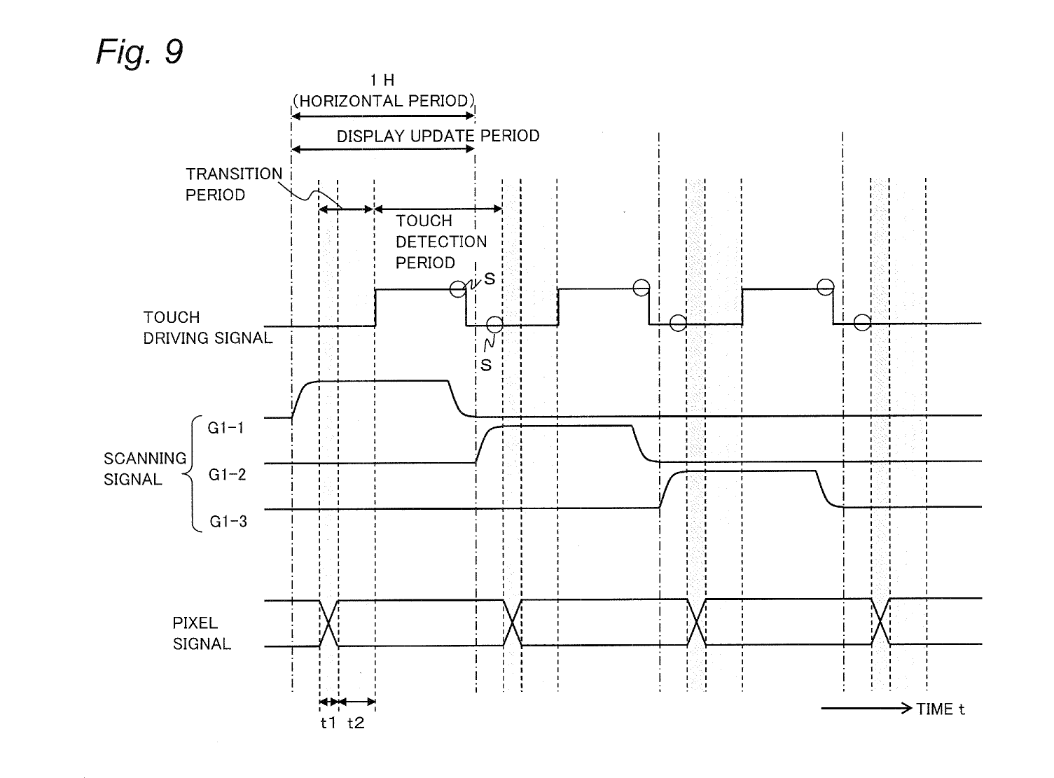

FIG. 9 is a timing chart for describing an example of relationship between a display update period and a touch detection period in one horizontal scanning period.

As illustrated in FIG. 9, during each display update period, scanning signals are input to the scanning signal lines 10 (G1-1, G1-2, . . . ), and pixel signals according to the input video signals are input to the video signal lines 9 which are connected to switching elements of the pixel electrodes of the respective pixels.

In the present disclosure, the touch detection period is provided in synchronized timing with the above-described display update period. The touch detection period is set as a period that follows transition period after the start of the display update period. Specifically, when voltage displacement of the scanning signal rising to a predetermined electric potential has converged (stabilized), the liquid crystal display device supplies a pulse voltage to the drive electrodes 11 as the driving signal to start the touch detection period at the point of displacement of an electric potential of the driving signal caused by rising of the pulse voltage. Further, touch detection timing S is set at two points that are a point immediately before a falling edge of the pulse voltage and a touch detection period end point. Here, the transition period is set as a period including a first-half period t1 in which pixel signals are displaced and a period t2 in which an electric potential of the common electrodes changes to an electric potential of new pixel signals as a result of the displacement of the pixel signals. The above setting is intended to prevent fluctuations in the electric potential of the common electrodes, which is caused by capacitive coupling of parasitic capacitance in the panel after the transition period of the pixel signals, from taking place during the touch detection period.

Touch detection operation during the touch detection period has been described with reference to FIGS. 3 and 4.

Although the touch detection timing S has been described as an example in the present embodiment, the touch detection timing may be other points of time. For example, the touch detection may be performed at a point of time at which a noise is not made by the liquid crystal display device.

In the description made with reference to FIG. 1 and FIGS. 7A to 9, it is assumed that in-cell touch panels are used in the liquid crystal display device. However, the touch panels of the present disclosure do not need to be the in-cell touch panels and may be out-cell touch panels or on-cell touch panels. In the out-cell touch panel or the on-cell touch panel, the scanning line drive circuit and the sensor drive circuit do not need to synchronize with each other.

### 1-2-3. Method of Detecting Touch Positions

Generally, when a plurality of touch operations (multi-touch operation) are performed simultaneously on a touch panel with a short distance between the touched positions, it is difficult for the touch panel to recognize each of the touch operations separately, since the detection values in the regions between touch positions have little difference from each other. Further, in the case where the touch panels 101 to 104 are joined together as in the liquid crystal display device according to the present embodiment, when a user touches one or more positions on the joint portion 20 or positions on the touch panels 101 to 104 across the joint portion 20, it is even more difficult for the liquid crystal display device to discriminate the plurality of touches. The present embodiment discloses a configuration for solving the above-described problems. Specifically, the position detection circuit 13 converts a detection value for each detection region so that difference in the detection values between adjoining detection regions is increased, and detects the touch positions based on the converted values. In converting the detection value, the position detection circuit 13 amplifies (emphasizes) the detection value in each of the detection regions according to a positional relationship between the detection region and the joint portion 20, and uses the amplified detection values. A method of detecting the touch positions by the position detection circuit 13 according to the present embodiment will be described below.

At first, it will be described that variation of the detection values when a touch operation is performed. User's touch operation is detected for each of divisions (detection regions) into which each screen of the touch panels 101 to 104 in the display unit 1 is divided in a matrix form. The division of the touch panels 101 to 104 is defined by the drive electrode 11 and the sensing electrode 12 which cross each other (see FIG. 3). When the display surface of the display unit 1 is touched by the user, detection values in the divisions including a touch position and the divisions around the touch position are changed. In the case where a joint portion 20 is touched, detection values in the divisions of the touch panels located on both sides of the touched joint portion 20 are changed.

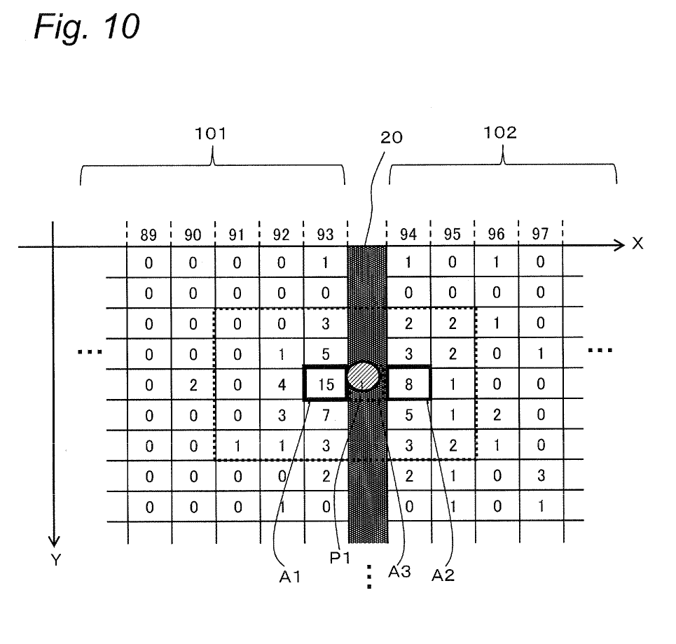

FIG. 10 is a diagram illustrating an example of a detection state on the touch panel in the case where the joint portion 20 is touched. FIG. 10 shows an example of a state in which the variation of electrostatic capacitance is detected over the touch panel 101 and the touch panel 102 in the case where a point P1 on the joint portion 20 is touched. In FIG. 10, a numerical value in each division within a range x≦93 in the x axis indicates the detection value detected in each division on the touch panel 101, and a numerical value in each division within a range x≧94 indicates the detection value detected in each division on the touch panel 102. It is assumed that the reference value for the detection value is 0.

The joint portion 20 is an insensible zone in which electrostatic capacitance is not detected, and therefore, in the case where the point P1 on the joint portion 20 is touched by the user, the touch is not detected at the point P1. However, in divisions which adjoin the touched point P1 on the touch panels 101 and 102 and are located on both sides of the joint portion 20, the detection values change from the reference value as a result of the variation of electrostatic capacitance caused by proximity of the object that touches the point P1. In the example illustrated in FIG. 10, the detection values detected in the divisions A1 and A2 located on both sides of the point P1 and in divisions in an area around the divisions A1 and A2 change. In the case where the detection values in divisions in an area spanning certain two touch panels change greatest from the reference value among the detection values in the respective divisions on the touch panels 101 to 104, the position detection circuit 13 senses that a region on the joint portion between the certain two touch panels is touched. For example, in the case of FIG. 10, the detection values in the divisions A1 and A2 change greatest from the reference value, and thus the position detection circuit 13 senses that a joint region A3 between the divisions A1 and A2 is touched.

Next, a process of detecting touch positions touched in a multi-touch operation by the position detection circuit 13 will be described.

### 1-2-4. Flow of Position Detecting Operation

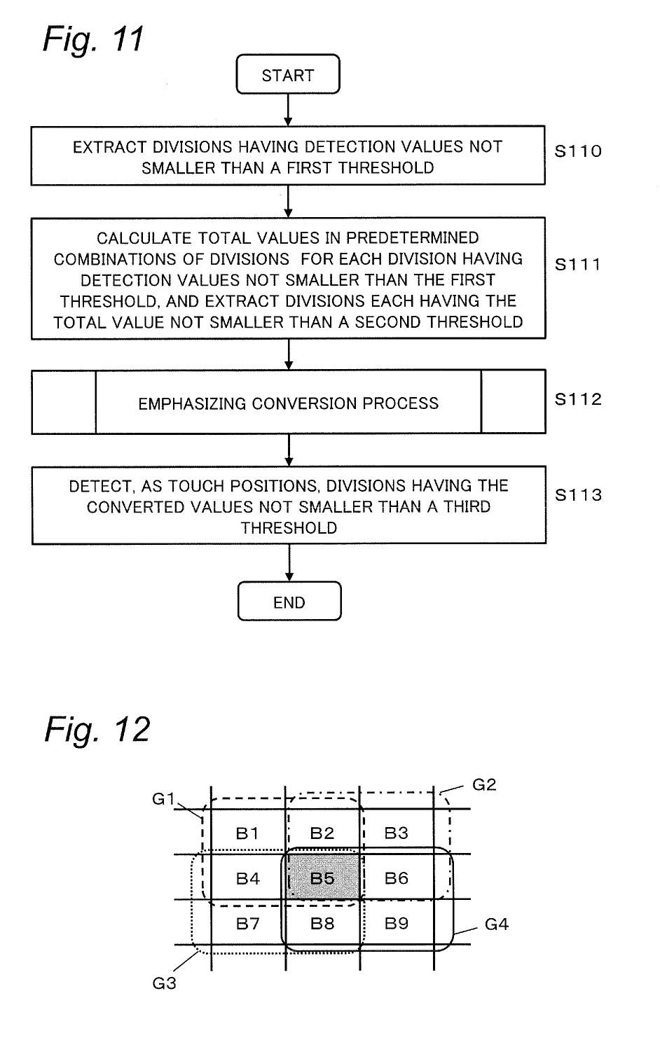

FIG. 11 is a flow chart showing an operation of the position detection circuit 13. FIG. 12 is a diagram for describing an exemplary processing performed by the position detection circuit 13. The flow is performed by the position detection circuit 13.

First, the position detection circuit 13 extracts divisions each having a detection value equal to or larger than a first threshold from the detection values detected by the signal detection circuit 7 illustrated in FIG. 1 (step S110). The first threshold is a threshold for detecting a division used to determine multi-touch, and is set to, for example, the same predetermined value for the respective touch panels 101 to 104.

Next, taking the divisions extracted in the process of step S110 as target divisions which are divisions to be processed, the position detection circuit 13 calculates, for each target division, total values of detection values in predetermined combinations of the target division and divisions around the target division, and then extracts divisions each having the calculated total value which is equal to or larger than a second threshold from the target divisions (step S111). The second threshold, which is a threshold for narrowing down divisions used to determine multi-touch, is set to a predetermined value to be compared with the respective total values. Details of the calculating method in the process of step S111 will be described later.

The position detection circuit 13 performs emphasizing conversion process on the detection values in the divisions extracted in step S111 (step S112). In the emphasizing conversion process, the position detection circuit 13 converts each of the detection values in divisions to be used for determining multi-touch (target detection regions) so that difference between the detection value in a target division subjected to the emphasizing conversion process and the detection values in the divisions around the target division (neighboring regions) are emphasized. Details of the emphasizing conversion process will be described later.

The position detection circuit 13 detects, as the touch positions, the divisions having the converted values which have been converted from the detection values in the emphasizing conversion process and are equal to or larger than a third threshold (step S113). The third threshold is a threshold for determining positions of the multi-touch based on the converted values obtained from the emphasizing conversion process, and is set to a predetermined value to be compared with the converted values for the respective divisions.

Now, the method of calculating the total value of the detection values in predetermined combinations of a target division for the calculation in the process of step S111 and divisions around the target division for the calculation of step S111 will be described with reference to FIG. 12. In FIG. 12, divisions B1 to B9 represent the divisions in which the detection values are detected on the touch panel. In the first embodiment, the position detection circuit 13 performs the calculation process of step S111 by using the detection values in four divisions including the division B5 to be processed in the calculation. Here, an exemplary calculation in a case where the division B5 is the target region for the calculation of step S111 will be described.

In the process of step S111, the position detection circuit 13 uses four groups G1 to G4 as a set of combinations of the target division (B5) and divisions around the target division (B5). The four groups G1 to G4 includes a group G1 (B1, B2, B4, B5), a group G2 (B2, B3, B5, B6), a group G3 (B4, B5, B7, B8), and a group G4 (B5, B6, B8, B9), each having the division B5 at one of the four corners in the Area of 2 rows×2 columns. The position detection circuit 13 calculates the total value of the detection values in each of the four groups G1 to G4. The position detection circuit 13 determines whether or not the total value of each of the groups is equal to or larger than the second threshold. When the total value of at least one of the four groups G1 to G4 is equal to or larger than the second threshold, the position detection circuit 13 extracts the division B5.

In the case where the target division adjoins the joint portion 20, some of the groups G1 to G4 which are set in the four directions from the target division as illustrated in FIG. 12 overlap the joint portion 20, and therefore, the position detection circuit 13 cannot obtain the detection value from the overlapping region. In this case, the position detection circuit 13 may exclude the groups overlapping the joint portion 20 from the calculation, for example, and compute the total value of the detection values only in the groups which do not overlap the joint portion 20.

The above-described process of step S111 is for removing noise data from the divisions used to determine multi-touch extracted in the process of step S110. If noise data having a value larger than the first threshold used in the process of step S110 occurs, it is expected that detection values in the divisions around the division having the noise data are not changed as greatly as the detection values in the divisions around the touch positions. Therefore, as in the process of step S111, performing the calculation by taking into account the detection values in the divisions around each of the divisions used to determine multi-touch can remove the noise data.

In the first embodiment, whether or not the total value of the detection values in the group is equal to or larger than the second threshold is determined on the basis of the detection values in the four groups each consisting of four divisions including the target division for the calculation, but the present disclosure is not limited thereto. The number of the groups to be used in the calculation, the number of the divisions included in each group, or the manner of combining the divisions to be grouped may be set appropriately.

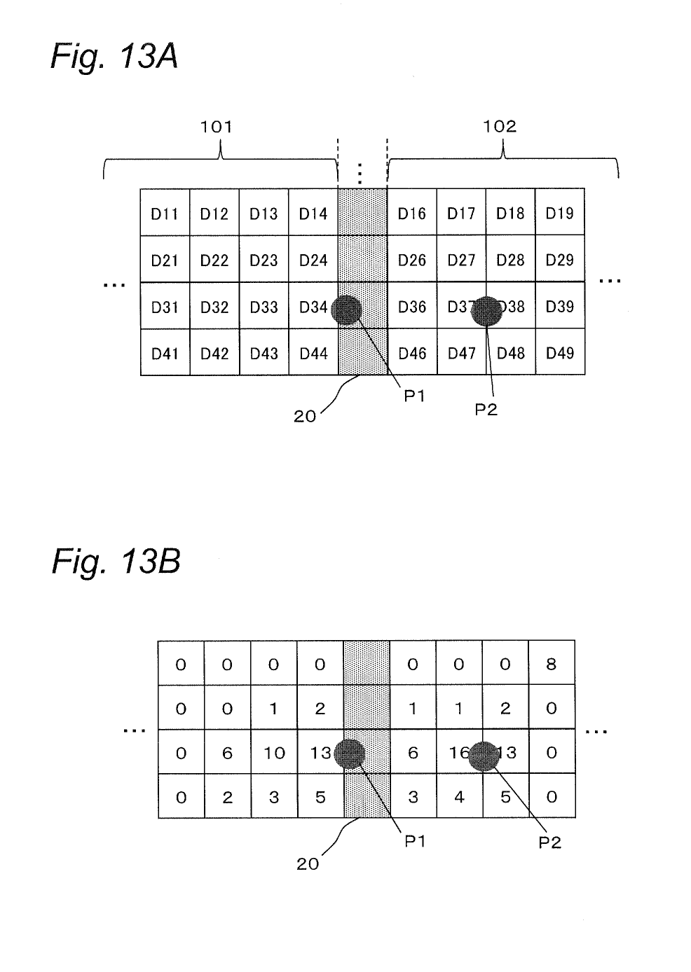

The detection of the touch positions of a multi-touch by the position detection circuit 13 will be described in detail below with reference to FIGS. 13A to 18.

FIGS. 13A and 13B are diagrams illustrating an example of multi-touch operation on the liquid crystal display device according to the embodiment. FIGS. 13A and 13B illustrate a case where the point P1 on the joint portion 20 and a point P2 on the touch panel 102 are touched substantially at the same time on the display surface of the display unit 1. In FIG. 13A, detection values D11 to D14, D21 to D24, D31 to D34, and D41 to D44 represent the detection values in the respective divisions of the touch panel 101, and detection values D16 to D19, D26 to D29, D36 to D39, and D46 to D49 represent the detection values in the respective divisions of the touch panel 102. In this example, it is assumed that each of the detection values is a single-byte data from 0 to 255. FIG. 13B illustrates an example of the detection values output from the signal detection circuit 7 in the case illustrated in FIG. 13A. In the example illustrated in FIG. 13B, the detection values in the divisions of the electrodes around the point P1 and the point P2 are changed from the reference value.

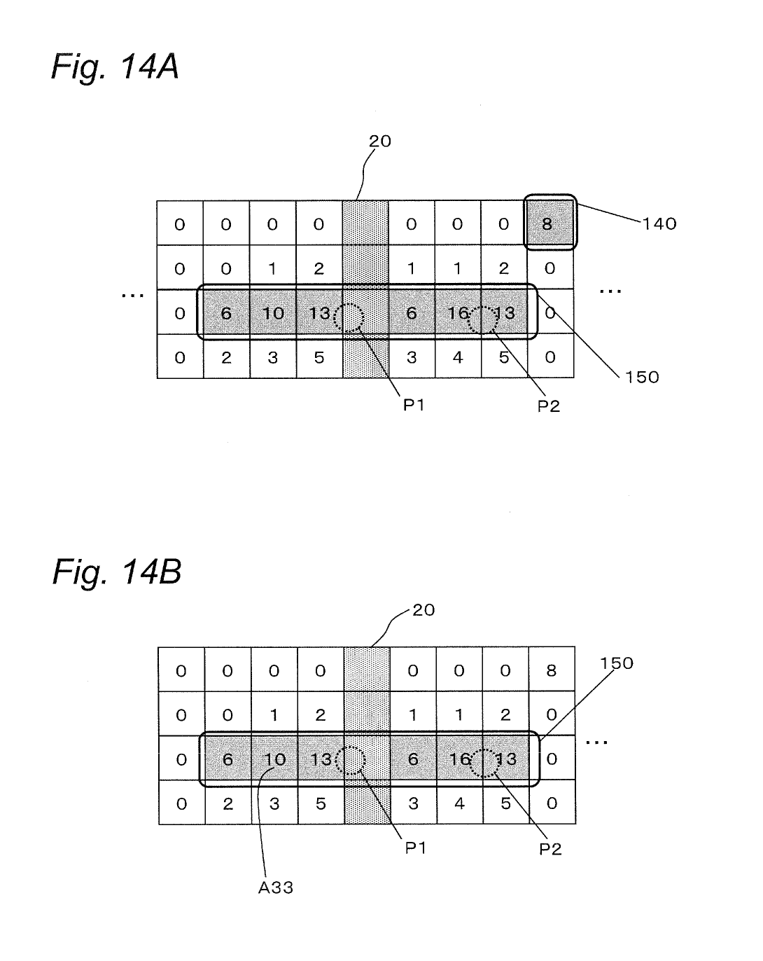

FIGS. 14A and 14B are diagrams for describing an exemplary process of detecting the multi-touch by the position detection circuit 13 in the example illustrated in FIGS. 13A, and 13B. FIG. 14A illustrates an exemplary processing of step S110 shown in FIG. 11, and FIG. 14B illustrates an exemplary processing of step S111.

First, the position detection circuit 13 extracts the divisions having detection values equal to or larger than the first threshold from the detection values output from the signal detection circuit 7 (step S110). Here, the first threshold is set to 6 as an example. In this case, regions 140 and 150 including each division having a detection value equal to or larger than the first threshold (6) are extracted as illustrated in FIG. 14A from the detection value distribution illustrated in FIG. 13B.

Next, the position detection circuit 13 performs the calculation process of step S111 that has been described with reference to FIG. 12 on the respective detection values in the regions 140 and 150. For example, as for the detection value 10 in the division A33 in the region 150, the detection values in the four groups illustrated in FIG. 12 are G1 (0, 1, 6, 10), G2 (1, 2, 10, 13), G3 (6, 10, 2, 3), and G4 (10, 13, 3, 5). Therefore, the total values of the respective groups T(G1), T(G2), T(G3), and T(G4) are T(G1)=17, T(G2)=26, T(G3)=21, and T(G4)=31. Here, in the first embodiment, the second threshold is set to 20 as an example. In this case, since the total values of the three groups T(G2), T(G3), and T(G4) are equal to or larger than 20, the division A33 is extracted. In the same manner, the position detection circuit 13 performs the same calculation on the detection values in the other divisions. Consequently, the calculated total values for the region 140 are smaller than the second threshold “20” since the divisions around the region 140 which is located far from the touched points P1 and P2 that have small detection values. On the other hand, the total values for the divisions in the region 150 are equal to or larger than the second threshold “20”. Therefore, the region 150 is extracted as illustrated in FIG. 14B.

Next, the position detection circuit 13 detects the touch positions in the determination target divisions for multi-touch extracted in the process of step S111.

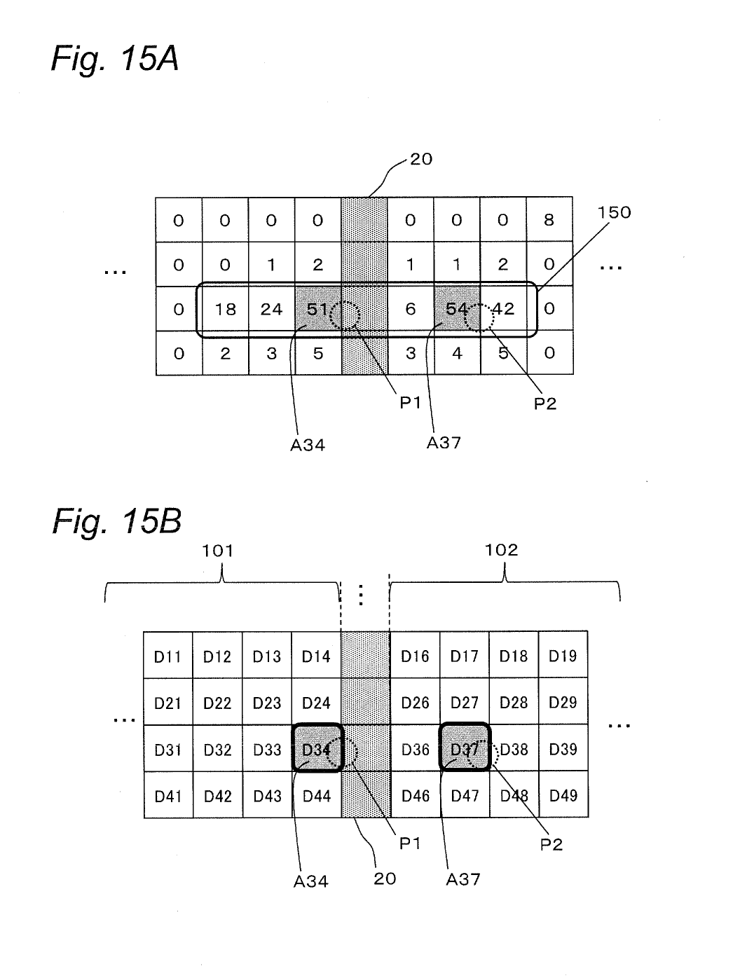

Specifically, the position detection circuit 13 performs the emphasizing conversion process to perform the calculation for emphasizing difference (change) in the detection values according to positional relationships of the detection regions (S112). FIG. 15A illustrates the result of the emphasizing conversion process performed on the detection values in the region 150 illustrated in FIG. 14B. Details of the emphasizing conversion process will be described later. As a result of the emphasizing conversion process, the detection values in the divisions A34 and A37 corresponding to the touched points P1 and P2 are converted into large values 51 and 54. In this way, the detection values of the touched points are greatly emphasized by the emphasizing conversion process.

FIG. 15B illustrates the determination result of the process of step S112 following the process shown in FIG. 15A. Here, the third threshold is set to 50 as an example. As illustrated in FIG. 15A, in the region 150, the detection values “54” and “51”, respectively, which are in the divisions A34 and A37 are larger than the third threshold “50”. Therefore, as illustrated in FIG. 15B, the position detection circuit 13 detects that a multi-touch has been performed on two points of the divisions A34 and A37.

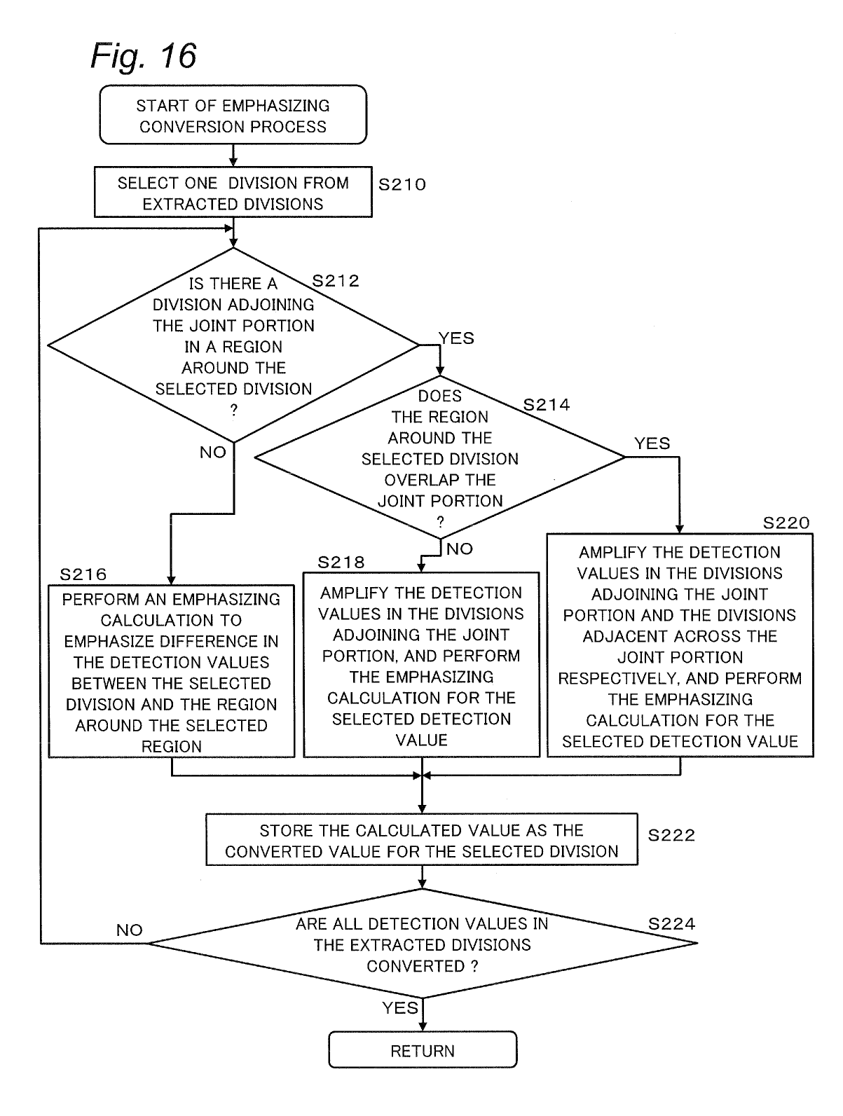

Now, details of the emphasizing conversion process of step S112 of FIG. 11 will be described. The calculation method for emphasizing difference (change) in the detection values which is performed in the emphasizing conversion process differs according to positional relationships between the target divisions for the calculation of converting detection values and the joint portion 20. In the first embodiment, the calculation varies in accordance with three cases. The calculation will be described below with reference to FIGS. 16 to 19.

### 1-2-4-1. Emphasizing Conversion Process

FIG. 16 is a flow chart for describing the emphasizing conversion process (step S112) of the position detection circuit 13.

First, the position detection circuit 13 selects one of the divisions extracted in the process of step S111 of FIG. 11 (S210). Next, the position detection circuit 13 determines whether or not there is a division adjoining the joint portion 20 around the selected division (S212).

When there is no division adjoining the joint portion 20 in a region neighboring the selected division (NO in S212), the position detection circuit 13 performs an emphasizing calculation to emphasize or increase the difference in the detection value between the selected region and a region around the selected region (S216).

On the other hand, when there is the division adjoining the joint portion 20 in the region around the selected division (YES in S212), the position detection circuit 13 determines whether or not the region around the selected division overlaps the joint portion 20 (S214). When the region around the selected division does not overlaps the joint portion 20 (NO in S214), the position detection circuit 13 amplifies the detection value in the division which is within the region around the selected division and also adjoins the joint portion 20 by a predetermined amplification factor. In this manner, the position detection circuit 13 performs the emphasizing calculation for emphasizing difference (change) between the detection value in the selected division and the detection values in divisions neighboring the selected division (S218).

On the other hand, when the region around the selected division overlaps the joint portion 20 (YES in S214), the position detection circuit 13 amplifies the detection value in the division which is neighbors the selected division and also adjoins the joint portion 20, and the detection value in the division which is adjacent to the selected division across the joint portion 20, respectively. The position detection circuit 13 performs the emphasizing calculation for emphasizing difference (change) between the detection value in the selected division and the detection values in divisions around the selected division by using the amplified detection values (S220).

The position detection circuit 13 stores the calculated value obtained from the calculation in any of the processes in steps S216, S218, and S220 as the converted value obtained from the emphasizing conversion process performed on the detection value in the selected division (S222). The position detection circuit 13 repeats the above-described process until the detection values of all the divisions extracted in the process of step S111 are converted (S224).

Details of the process of each of steps S216, S218, and S220 will be described below.

### (1) Process of Step S216

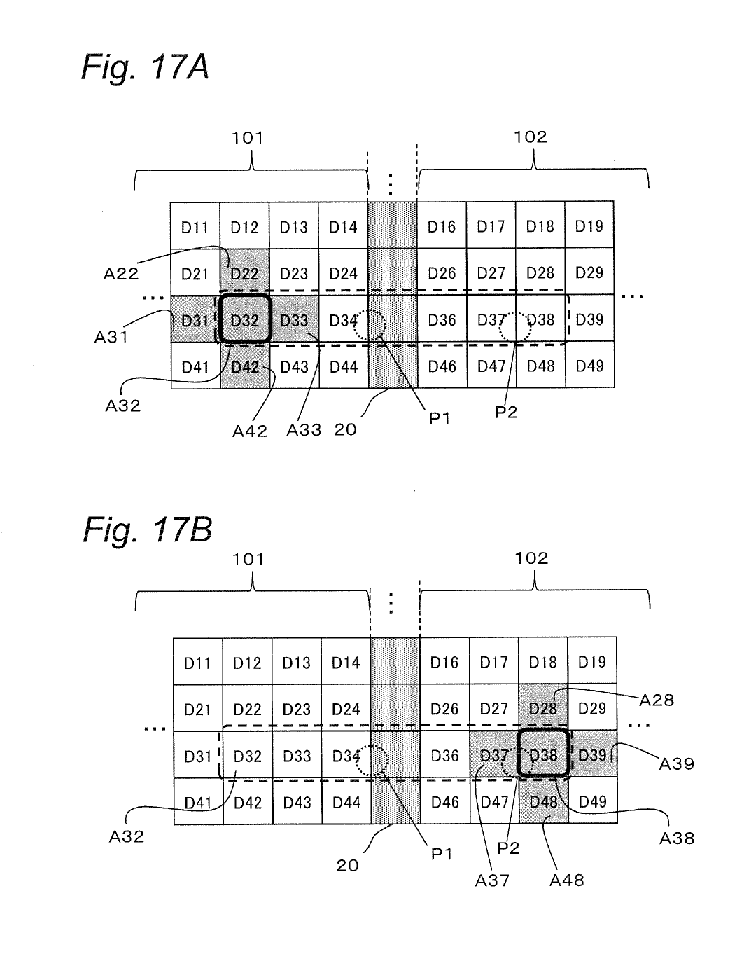

The process of step S216 is performed when all of a calculation target division (target detection region), which is a target division subjected to the emphasizing calculation, and the region around the calculation target division are located at a distance from the joint portion 20. The process will be described below with reference to FIGS. 17A and 17B.

FIGS. 17A and 17B are diagrams for describing an example of the calculation of the position detection circuit 13 performed when all of the calculation target division and the region around the calculation target division are located at a distance from the joint portion 20. In FIGS. 17A and 17B, the detection values D11 to D14, D21 to D24, D31 to D34, and D41 to D44 represent the detection values in the respective divisions of the electrodes of the touch panel 101, and the detection values D16 to D19, D26 to D29, D36 to D39, and D46 to D49 represent the detection values in the respective divisions of the electrodes of the touch panel 102. In this example, it is assumed that each of the detection values is a single-byte data from 0 to 255. FIG. 17A is a diagram for describing the calculation for the touch panel 101 and FIG. 17B is a diagram for describing the calculation for the touch panel 102.

In FIG. 17A, the division selected in step S210 is a division A32 of which detection value is D32. The divisions (neighboring regions) around the selected division A32 are four divisions A22, A42, A31, and A33 which adjoin the upper side, the lower side, the left side, and the right side of the selected division A32, respectively, and are all located at a distance from the joint portion 20. In this case, the position detection circuit 13 emphasizes difference between the detection value D32 in the selected division A32 and the detection values in the divisions around the selected division A32 by using the detection values D32, D22, D31, D33, and D42 in the divisions A32, A22, A31, A33, and A42. The position detection circuit 13 calculates the converted value P32 obtained by the conversion of the detection value D32 according to the following equation.

P32=D32×α−(D22+D31+D33+D42) (1)

In the above equation, the coefficient α is a coefficient set according to the peak property of the detection value, and for example, α=5 in the present embodiment. In this case, the position detection circuit 13 adds, to the detection value D32, the difference between the detection value D32 in the selected division A32 and the detection values in the divisions around the selected division A32. In the example of FIG. 14B, the converted value P32=6×5−(0+0+10+2)=18.

In FIG. 17B, the division selected in step S210 is a division A38 of which detection value is D38. The divisions around the selected division A38 are four divisions A28, A48, A37, and A39 which are located on the upper side, the lower side, the left side, and the right side of the selected division A32, respectively, and are all located at a distance from the joint portion 20. In this case, the position detection circuit 13 emphasizes difference between the detection value D38 in the selected division A38 and the detection values in the divisions around the selected division A38 by using the detection values D38, D28, D37, D39, and D48 in the divisions A38, A28, A37, A39, and A48. In the same manner of the above equation (1), the position detection circuit 13 calculates the converted value P38 obtained by the conversion of the detection value D38 according to P38=D38×α−(D28+D37+D39+D48). Here, the coefficient α is the coefficient set according to the peak property of the detection value. In the example of FIG. 14B, when α=5, the converted value P38=13×5−(2+16+0+5)=42.

As described above, in the calculation process of step S216, the detection values for the respective target divisions are converted so that difference between the detection value in the target division and the detection values in the divisions around the target division are emphasized. Since the detection value in the touched division is larger than the detection values in the divisions around the touched division, all the difference between the detection value in the division including the touched point and the detection values in the divisions around the division including the touched point are positive. Therefore, the detection value in the division including the touched point is converted into a larger value in the calculation process of step S216.

### (2) Process of Step S218

The process of step S218 is performed when a part of region around a target division for the calculation of step S218 is located adjoining the joint portion 20.

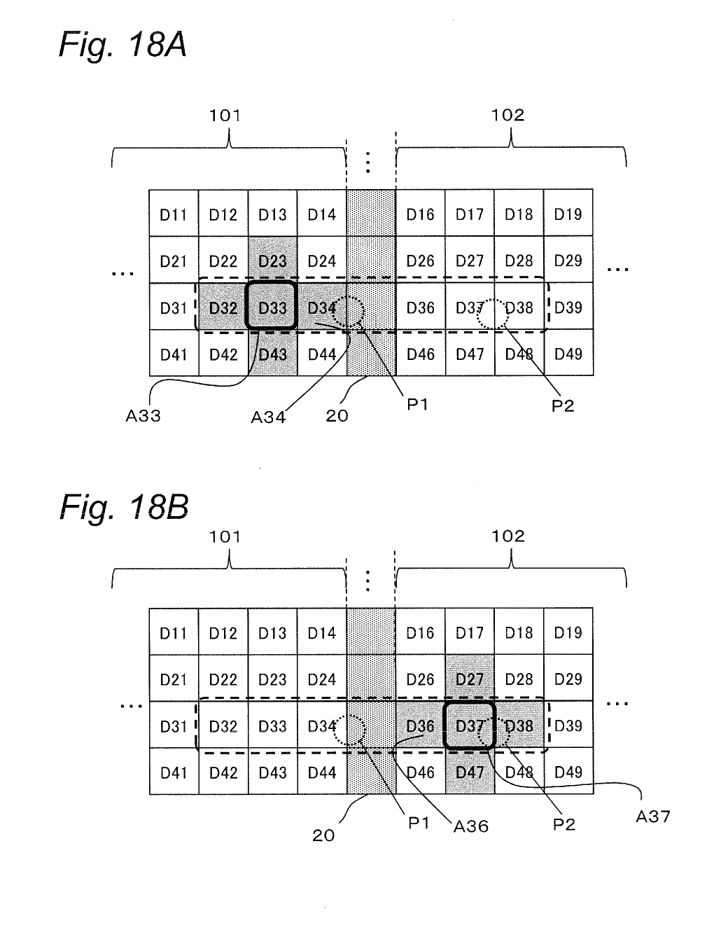

FIGS. 18A and 18B are diagrams for describing an example of the calculation of the position detection circuit 13 performed when a part of a predetermined region around the calculation target division adjoins the joint portion 20. In FIGS. 18A and 18B, the detection values D11 to D14, D21 to D24, D31 to D34, and D41 to D44 represent the detection values in the respective divisions of the electrodes of the touch panel 101, and the detection values D16 to D19, D26 to D29, D36 to D39, and D46 to D49 represent the detection values in the respective divisions of the electrodes of the touch panel 102. In this example, it is assumed that each of the detection values is a single-byte data from 0 to 255. FIG. 18A is a diagram for describing the calculation for the touch panel 101 and FIG. 18B is a diagram for describing the calculation for the touch panel 102.

In FIG. 18A, the division selected in step S210 is a division A33 of which detection value is D33. The division A34 adjoins the joint portion 20 among four divisions which are located each on the upper side, the lower side, the left side, and the right side of the selected division A33, respectively. In this case, the position detection circuit 13 emphasizes difference between the detection value D33 in the selected division A33 and the detection values in the divisions around the selected division A33 by using the detection values D33, D23, D32, D34, and D43. The position detection circuit 13 calculates the converted value P33 obtained by the conversion of the detection value D33 according to the following equation.

P33=D33×α−(D23+D32+D43)−D34×β1 (2)

In the above equation, the coefficient α is the coefficient set according to the peak property, and an amplification coefficient β1 is a coefficient for amplifying the detection value attenuated by the property of the touch panel 101 adjoining the joint portion 20. The amplification coefficient β1 is equal to or larger than 1. In the example of FIG. 14B, when α=5 and β1=1.2, the converted value P33=10×5−(1+6+3)−13×1.2=24.

In FIG. 18B, the division selected in step S210 is a division A37 of which detection value is D37. The division A36 adjoins the joint portion 20 among four divisions which are located each on the upper side, the lower side, the left side, and the right side of the selected division A37. In this case, the position detection circuit 13 emphasizes difference between the detection value D37 in the selected division A37 and the detection values in the divisions around the selected division A37 by using the detection values D37, D27, D36, D38, and D47. In the same manner of the above equation (2), the position detection circuit 13 calculates the converted value P37 obtained by the conversion of the detection value D37 according to P37=D37×α−(D27+D38+D47)−D36×γ1. Here, the coefficient α is the coefficient set according to the peak property, and an amplification coefficient γ1 is a coefficient for amplifying the detection value attenuated by the property of the touch panel 102 adjoining the joint portion 20. The amplification coefficient γ1 is equal to or larger than 1. In the example of FIG. 14B, when α=5 and γ1=1.4, the converted value P37=16×5−(1+13+3)−6×1.4=54.

As described above, in the calculation process of step S218, the detection value in the division adjoining the joint portion 20 is amplified as in the equation (2) and is used. Accordingly, even if the joint portion 20 adjoins any of the divisions around the touched point, the detection value in the division is emphasized more greatly as the division is closer to the touched point.

### (3) Process of Step S220

The process of step S220 is performed when a part of the region around the calculation target division includes the joint portion 20.

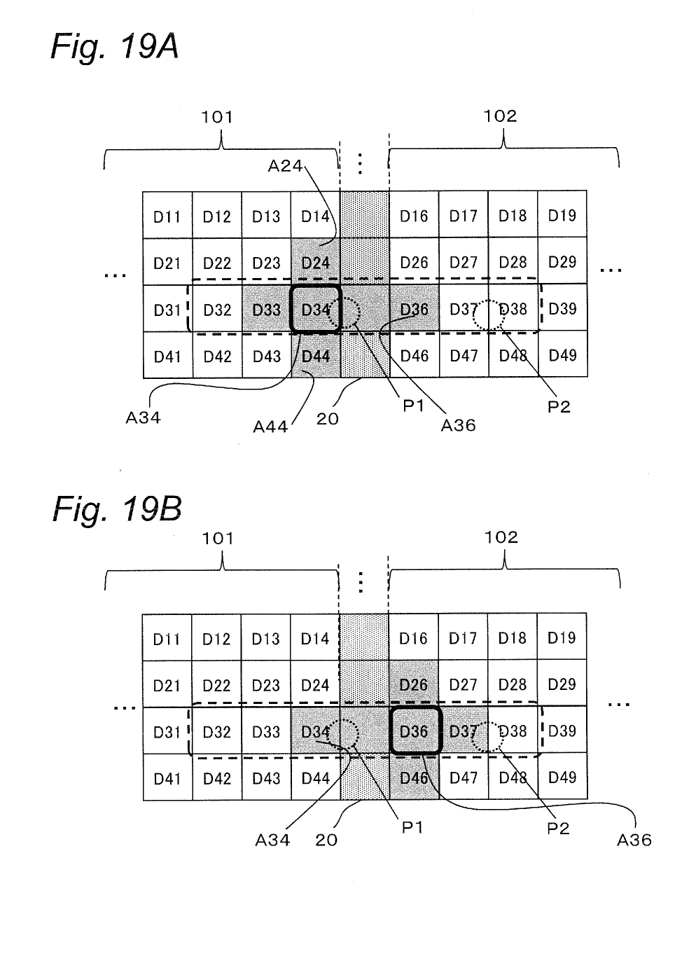

FIGS. 19A and 195 are diagrams for describing an example of the calculation of the position detection circuit 13 performed when a part of the region around the calculation target division includes the joint portion 20. In FIGS. 19A and 19B, the detection values D11 to D14, D21 to D24, D31 to D34, and D41 to D44 represent the detection values in the respective divisions of the electrodes of the touch panel 101, and the detection values D16 to D19, D26 to D29, D36 to D39, and D46 to D49 represent the detection values in the respective divisions of the electrodes of the touch panel 102. In this example, it is assumed that each of the detection values is a single-byte data from 0 to 255. FIG. 19A is a diagram for describing the calculation for the touch panel 101 and FIG. 19B is a diagram for describing the calculation for the touch panel 102.

In FIG. 19A, the division selected in step S210 is a division A34 of which detection value is D34. The selected division A34 adjoins the left side of the joint portion 20. In this case, for the joint portion 20 on the right side of the division A34, the position detection circuit 13 cannot detect a difference from the detection value D34. Therefore, in place of the detection value on the right side of the division A34, the position detection circuit 13 uses the detection value D36 in the division A36 that is adjacent to the right side of the division A34 across the joint portion 20. Specifically, the position detection circuit 13 emphasizes difference between the detection value D34 in the selected division A34 and the detection values in the divisions around the selected division A34 by using the detection values D34, D24, D33, D44, and D36. The position detection circuit 13 calculates the converted value P34 obtained by the conversion of the detection value D34 according to the following equation.

P34=D34×α×β1−D33−(D24+D44)×β1−D36×γ2 (3)

In the above equation, the coefficient α is the coefficient set according to the peak property, and the amplification coefficient pi is a coefficient for amplifying the detection value which is attenuated by the property of the touch panel 101 adjoining the joint portion 20. The amplification coefficient γ2 is a coefficient for amplifying the detection value which is attenuated by the adjacency of the touch panel 102 to the calculation target division A34 across the joint portion 20. The amplification coefficient γ2 is equal to or larger than 1.

In the equation (3), the calculation target detection value D34 is amplified by the amplification factor α×β1 because the division A34 adjoins the joint portion 20. The detection values D24 and D44 are amplified by the amplification factor pi because the divisions A24 and A44 around the calculation target division A34 adjoin the joint portion 20 on the touch panel 101. The detection value D36 is amplified by the amplification factor γ2 because the calculation target division A34 and the division A36 on the touch panel 102 are adjacent to each other across the joint portion 20. In the example of FIG. 14B, when α=5, β1=1.2, and γ2=1.4, the converted value P34=13×5×1.2−10−(2+5)×1.2−6×1.4=51.

In FIG. 19B, the division selected in step S210 is the division A36 of which the detection value is D36. The selected division A36 adjoins the right side of the joint portion 20. In this case, since the joint portion 20 is on the left side of the selected division A36, the position detection circuit 13 uses the detection value D34 in the division A34 adjacent to the left side of the division A36 across the joint portion 20. Specifically, the position detection circuit 13 emphasizes difference between the detection value D36 in the selected division A36 and the detection values in the divisions around the selected division A36 by using the detection values D36, D34, D26, D46, and D37. In the same manner of the above equation (3), the position detection circuit 13 calculates the converted value P36 obtained by the conversion of the detection value D36 according to P36=D36×α×71−D37−D34×β2−(D26+D46)×γ1. Here, the coefficient α is the coefficient set according to the peak property, and the amplification coefficient γ1 is the coefficient for amplifying the detection value attenuated by the property of the touch panel 102 adjoining the joint portion 20. The amplification coefficient β2 is a coefficient for amplifying the detection value attenuated by the adjacency of the touch panel 101 to the calculation target division A36 across the joint portion 20. In the example of FIG. 14B, when α=5, β2=1.2, and γ1=1.4, the converted value P36=6×5×1.4−16−13×1.2−(1+2)×1.4=6.

As described above, in the calculation process of step S220, for calculation for emphasizing the difference between divisions adjoining the joint portion 20, the detection value in the division adjoining the joint portion 20 is amplified and also the detection values in the divisions adjacent to each other across the joint portion 20 are amplified as in the equation (3), and the amplified values are used. As a result of the calculation process, the detection value in the division A34 corresponding to the touched point P1, for example, is amplified from 13 to 51. On the other hand, the detection value in the division A36 is converted from 6 to 6, and is not amplified. Thus, the detection value in the division is emphasized more greatly as the division is closer to the touched point, even if the division is around the joint portion 20.

According to the above-described emphasizing conversion process, the detection value in the division is emphasized more greatly as the target division is closer to the touched point. Therefore, with the third threshold set appropriately, the position detection circuit 13 can detect divisions on which a multi-touch is performed in the region 150 including the plurality of divisions.

### 1-3. Effects and the Like

As described above, in the present embodiment, the liquid crystal display device includes the plurality of touch panels 101 to 104 and the position detection circuit 13. Each of the touch panels 101 to 104 detects a touch operation and outputs the detection values for the plurality of divisions. The position detection circuit 13 detects the touch position based on the detection values from the touch panels 101 to 104. The position detection circuit 13 performs the emphasizing conversion process for converting the detection value of a calculation target division to emphasize difference in detection values between the calculation target division and a region around the calculation target division which are the divisions within a predetermined range around the the calculation target division. The calculation target division is a division to be subjected to the emphasizing conversion process. The position detection circuit 13 detects the touch positions based on the converted value obtained by the emphasizing conversion process.

According to the above-described configuration, since difference between the detection value in each of the divisions and the detection values in the divisions in the neighboring regions of the aforementioned division are emphasized, the liquid crystal display device can separate the plurality of touch positions from each other and increase detection accuracy of a multi-touch operation.

The emphasizing conversion process performs the calculation for emphasizing difference between the detection value in the target division and the detection values in the neighboring regions of the target division according to the positional relationship between the target division and the joint portion 20. According to the process, even though there is the joint portion 20, the detection accuracy of a multi-touch operation by amplifying the detection values can be improved in the divisions around the joint portion 20. Therefore, even though the touch panels are joined together to realize a large display surface, the multi-touch separating function can be improved.

### Other Embodiments

As described above, the first embodiment has been described as an exemplification of the technology disclosed in the present application. However, the technology in the present disclosure can also be applied to an embodiment in which an alteration, substitution, addition, or omission or the like has been implemented as appropriate without restriction to the first embodiment. Furthermore, it is also possible to combine the constituent elements described in the aforementioned the first embodiment to constitute a new embodiment.

Accordingly, examples of other embodiments are given hereinafter.

In the first embodiment, although the display unit 1 includes four touch panels, the number of the touch panels is not limited thereto.

In the first embodiment, the display unit is configured by a plurality of liquid crystal panels joined together. The display unit may be configured by one liquid crystal panel. For example, a plurality of off-cell touch panels joined together may be arranged on the display unit of one liquid crystal panel. Alternatively, electrodes for detecting electrostatic capacitance in the touch sensor may be provided on the display surface of the display unit along the joint regions having predetermined widths. Any configuration is possible as long as one or more touch panels having a touch sensor function are arranged on a display surface which displays an image.

Although the liquid crystal panels are used as the display unit in the first embodiment, the display unit may be other than the liquid crystal panels. For example, an organic EL display, an LED display, or an electronic paper display may be used as the display unit.

In the first embodiment, the position detection circuit 13 is configured by a semiconductor chip of each circuit mounted on a flexible wiring board, a printed circuit board, or a glass substrate. The position detection unit may be configured by an arithmetic processing circuit such as a CPU and a memory such as a ROM and a RAM, so that the function thereof is realized by executing a predetermined program. The function of the position detection unit may be realized by a dedicated designed electronic circuit.

In the first embodiment, a case where a multi-touch is performed on the touch panel 101 and the touch panel 102 across the joint portion 20 has been described as an example. Also in a case where a multi-touch is performed on the touch panel 103 and the touch panel 104 across the joint portion 20, calculation can be performed in the same manner as the above-described example.

Further in the first embodiment, the calculation method in the emphasizing conversion process performed on a multi-touch on the touch panels 101 and 102 which are adjacent to each other across the joint portion 20 in the x-direction has been described as an example. The same calculation method can be applied to the touch panel 101 and the touch panel 103 which are adjacent to each other across the joint portion 20 in the y-direction or on the touch panel 102 and the touch panel 104 which are adjacent to each other across the joint portion 20.

In the emphasizing conversion process in the first embodiment, the amplification of the detection values is performed based on confirmation of positional relationships between the divisions of the detection values and the joint portion in performing the calculation for emphasizing difference in the detection values. However, prior to the calculation for emphasizing difference in the detection values, the amplification of the detection values may be performed based on confirmation of positional relationships between the divisions of the detection values and the joint portion in advance.

The first to third thresholds, the values of α, β1, β2, γ1, and γ2, and the computing equations are merely examples, and the present disclosure is not limited thereto, and therefore they may be set appropriately. Also, the values of α, β1, β2, γ1, and γ2 may be set for each of the touch panels 101 to 104. For example, the amplification coefficient β1 for amplifying the detection value on the touch panel 101 adjoining the joint portion 20 may be separated into an amplification coefficient β11 for a division adjacent to the touch panel 102 across the joint portion 20 and an amplification coefficient β12 for a division adjacent to the touch panel 103 across the joint portion 20. The amplification coefficient β11 and the amplification coefficient β12 may take different values.

In the first embodiment, a case where a multi-touch is performed on two points has been described as an example. The present disclosure can be applied to a multi-touch on three or more points.

Since the emphasizing calculation for emphasizing a change in the detection values in the first embodiment is merely an example, the detection values in the divisions other than the divisions which are located on the upper side, the lower side, the left side, and the right side of the calculation target division may be used in place of the divisions used in the equations (1) to (3). For example, the divisions around the calculation target division (neighboring regions) are not limited to the divisions which are located on the upper side, the lower side, the left side, and the right side of the calculation target division. For example, the neighboring regions may be divisions in the area of 3 rows×3 columns with its center as the calculation target division. Alternatively, the divisions in the area of M rows×N columns (M, N=2, 3, . . . ) with its center as the calculation target division may be used for the neighboring regions.

In the first embodiment, the process of step S111 is performed in the operation of the position detection circuit 13 shown in FIG. 11, however, the process of step S111 may be omitted. In this case, the position detection circuit 13 performs the emphasizing conversion process of step S112 on each of the divisions extracted in the process of step S110. By performing the process of step S111, the position detection circuit 13 can reduce the throughput in the emphasizing conversion process.

In the first embodiment, in the case that the division to be subjected to the calculation of the process of step S111 adjoins the joint portion 20, only the groups which do not overlap the joint portion 20 are used. Alternatively, using the group that overlaps the joint portion 20 with the divisions adjacent to the group across the joint portion 20, the position detection circuit 13 may calculate the total value of the detection values in the group.

This application claims priority of Japanese Patent Application No.: 2014/061338 filed on Mar. 25, 2014, and Japanese Patent Application No.: 2014/201771 filed on Sep. 30, 2014, the contents of which are incorporated herein by reference.

### INDUSTRIAL APPLICABILITY

The present disclosure may be applied to a large display device made of a plurality of touch panels each having a capacitive coupling type input function such as an electronic blackboard.

What is claimed is:

1. An input device comprising:
a touch sensor configured to detect touch operations and output a detection value for each of detection regions; and
a position detection unit configured to detect touch positions touched by the touch operations, based on the detection values from the touch sensor, wherein
the position detection unit
performs emphasizing conversion process for converting a detection value of a target detection region to emphasize difference in detection values between the target detection region and neighboring regions which are the detection regions within a predetermined range around the target detection region, the target detection region being a detection region to be subjected to the emphasizing conversion process; and
detects the touch positions based on the converted detection value obtained by the emphasizing conversion process.

2. The input device according to claim 1, wherein
the touch sensor includes a plurality of touch panels which are joined together via a joint portion, and
the emphasizing conversion process
performs an emphasizing calculation for emphasizing difference in detection values between the target detection region and neighboring regions according to positional relationship between the target detection region and the joint portion.

3. The input device according to claim 2, wherein
in the case where the neighboring regions around the target detection region adjoins the joint portion, the emphasizing conversion process performs the emphasizing calculation,
by amplifying detection values in detection regions adjoining the joint portion in the neighboring regions, and by using the amplified detection values.

4. The input device according to claim 2, wherein
in the case where the target detection region adjoins the joint portion, the emphasizing conversion process performs the emphasizing calculation,
by amplifying detection values in detection regions adjoining the joint portion in the neighboring regions and detection values in detection regions adjacent to the target detection region across the joint portion in the neighboring regions respectively, and by using the amplified detection values.

5. The input device according to claim 2, wherein
in the case where the target detection region and the neighboring regions around the target detection region do not adjoin the joint portion,
the emphasizing conversion process performs the emphasizing calculation so that the difference between the detection value in the target detection region and the detection values in the neighboring regions is emphasized.

6. The input device according to claim 1, wherein
the position detection unit
calculates total values of detection values in predetermined combinations of a detection region having a detection value not smaller than a predetermined threshold and detection regions around the detection region having the detection value not smaller than the predetermined threshold, and
extracts the target detection regions based on the calculated total values.

7. The input device according to claim 1, wherein
the touch sensor comprises a plurality of first and second electrodes arranged to cross each other, and outputs the detection value by detecting variation of electrostatic capacitance between the first and second electrodes.

8. A display device comprising:
the input device according to claim 1; and
a display unit having a display surface for displaying an image.
